(19) United States
(12) Patent Application Publication
(10) Pub. No.: US 2023/0263189 A1
(43) Pub. Date: Aug. 24, 2023

(54) ADDITIVE FOR ANIMALS THAT CONTAIN SAPONINS, PHENOLIC COMPOUNDS AND P-CIMENOL, AND PROCEDURE FOR ITS OBTENTION

(71) Applicant: BIOVET S.A., Constanti (ES)

(72) Inventor: Jaime BORRELL VALLS, (US)

(21) Appl. No.: 18/041,055

(22) PCT Filed: Jun. 9, 2022
(86) PCT No.: PCT/IB2022/055388

§ 371 Date: Feb. 8, 2023

(30) Foreign Application Priority Data
Jul. 7, 2021 (ES) P202130637

(51) Int. Cl. A23K 10/30; A23K 20/111

(52) U.S. Cl. CPC A23K 10/30; A23K 20/111

(57) ABSTRACT

The current invention refers to an additive for animals composed of saponins, phenolic compounds and p-cimenol, and to the procedure for its obtention.

### FIELD OF THE INVENTION

The current invention refers to the field of animal feed. More specifically, it refers to an additive for animals composed of saponins, phenolic compounds and p-cimenol, and to the procedure for its obtention.

### BACKGROUND OF THE INVENTION

Air quality in the farms is an important factor [1], as the animal welfare, and the productive and economic performance depend on it.

In intensive livestock farming, which is widespread all around the world, animals are raised at high densities, usually in places with insufficient ventilation. These factors lead to an insufficient gas exchange with the outside and cause problems derived from a poor air quality and linked to high concentrations of some gases, particularly ammonia, despite others may also accumulate, such as carbon dioxide [1] (FIG. 1)

Ammonia is one of the most harmful gases produced in the farms. It comes from the decomposition by microorganisms of protein compounds present in urine and feces [1]-[3] and, due to it is highly volatile and easily evaporates, it rapidly decreases air quality.

It is irritant and produces lesions in the respiratory tract ranging from paralysis and loss of cilia of the tracheal mucosa surface to necrosis of the epithelium. The affected animals cannot eliminate dust particles, microorganisms or other harmful agents from the respiratory mucosa. This situation favors the mentioned harmful agents to reach the lungs and the air sacs (in the case of birds) and lead to severe respiratory disorders.

Ammonia, apart from being a predisposing factor for respiratory diseases, causes an increase in stress due to odors and respiratory discomfort, which causes immunosuppression and a greater susceptibility of animals of suffering infections. This gas, therefore, increases the probability in animals to suffer respiratory diseases, such as pneumonia, and other non-respiratory diseases, such as neonatal mortality, cannibalism and skin and ocular lesions 131.

Hence, there is the need to control and reduce ammonia emissions in the farms in order to achieve good performance results and maintain animal welfare.

In this regard, the current inventors developed an additive for animals based on saponins, phenolic compounds (also called pronutrients [4]), and p-cimenol from plant extracts. This additive decreases the environmental concentrations of ammonia in the farms.

### SUMMARY OF THE INVENTION

The aim of the invention refers to defining the composition of the additive for animals that contains saponins, phenolic compounds and p-cimenol; as well as to define the procedure for its obtention.

### BRIEF DESCRIPTION OF THE DRAWINGS

FIG. 1. Maximum recommended levels of ammonia and carbon dioxide in poultry and pig farms.

FIG. 2. Generic structure of spirostans, obtained by hydrolysis of saponins (aglycon part of spirostanol-type saponins). They have 6 rings (A-F) and 4 methylations located in the carbons 10, 13, 20 and 25. The union with monosaccharides through a glycosidic bond forms the saponins.

FIG. 3. (a) Generic structure of furostans, obtained by hydrolysis of the saponins (aglycon part of furostanol-type saponins), which have 5 rings (A-E). (b) Structure of Glc radicals.

FIG. 4. Chemical reaction of the decomposition of urea to ammonia and carbon dioxide by the enzyme urease, a reaction that is performed by ammonia-producing bacteria.

FIG. 5. Chemical structure of resveratrol, with two phenolic rings.

FIG. 6. Basic structure of yuccaols (A-E) with three phenolic rings and multiple free radicals.

FIG. 7, Chemical structure of p-cimenol.

FIG. 8. Flowchart to obtain a concentrate of saponins from the stem extract of Yucca schidigera.

FIG. 9. Flowchart to obtain a concentrate of phenolic compounds from the stem extract of Yucca schidigera.

FIG. 10. Flowchart to obtain a concentrate of p-cimenol from the leaf extract of Thymus vulgaris.

FIG. 11. Distribution of the composting pits, where the areas of the pits 1, 5 and 10, where the environmental ammonia measurements were made.

FIG. 12. Results of the application of the composition of the invention in composting pits after one month of its administration. The reduction percentages in each pit are shown.

FIG. 13. Evolution of environmental ammonia (NH₃) concentrations in ppm in a pig farm where measurements are made for 6 days at 7:00 h, 12:00 h and 17:00 h.

### DESCRIPTION OF THE INVENTION

The first issue of this invention refers to the composition of an additive for animals composed of saponins, phenolic compounds, and p-cimenol in powder and liquid. Preferably, these animals refer to livestock species including, but not limited to, ruminants, pigs, and poultry.

Saponins obtained from Yucca schidigera

In a preferred form, saponins are present in at least 2.25% by weight of the composition of the current invention. These saponins are obtained, preferably, from a concentrated stem extract of Yucca schidigera, more preferably between 6 and 13% by weight.

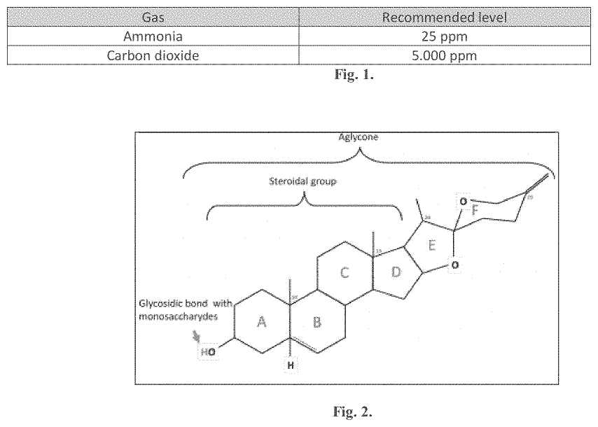

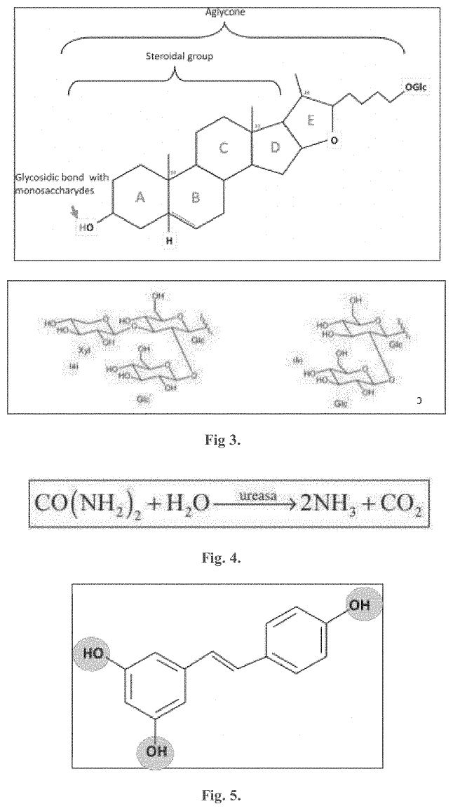

Saponins from yucca are glycosides of steroids or triterpenoids that can be of the spirostanol (FIG. 2) and furostanol (FIG. 3) types.

=Several positive effects are attributable to saponins on the reduction of environmental ammonia, among them, the following are highlighted:
the reduction effect of the ammonia and the odor in animal dejections, based on their (limited) antimicrobial activity against ammonia-producing microorganisms,
the inhibition of gastrointestinal ureases (FIG. 4);
their direct binding with ammonia.
and the stimulation of microorganisms that produce organic acids [5], which react with ammonia, forming less toxic salts than the original compound and that neutralize the alkaline waste from animals and, thus, decrease the ammonia volatility [6].

Ultimately, the supplementation of the feed with saponins produces a positive effect on the growth rate, feed efficiency, health and animal welfare [7].

Phenolic Compounds Obtained from Yucca schidigera

In yet another preferred form, phenolic compounds are present in at least 3.5% by weight of the composition on the current invention.

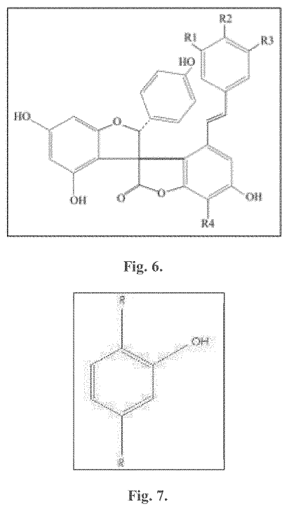

In an applicable form of all the forms of the current invention where the phenolic compounds are mentioned, these phenolic compounds are preferably resveratrol (FIG. 5) or yuccaols (FIG. 6) or a combination of them [8]. In total, resveratrol and yuccaols are present, preferably, in the stem extract of Yucca schidigera, and more preferably in a w eight of 9.4%. This percentage considers the sum of these two main phenolic compounds.

These phenolic compounds also have the ability to reduce the environmental ammonia [9].

p-Cimenol Obtained from Thymus vulgaris

In a preferred form, p-cimenol is present in at least 1.6% by weight of the composition of the current invention. This compound is present, preferably, in a concentrated extract of Thymus vulgaris, more preferably in a percentage by weight between 15 and 17%.

P-cimenol (FIG. 7) is a compound whose bactericidal, fungicidal and preservative functions are well-known [10] and that is present in many botanical varieties, such as Thymus vulgaris.

Laboratory and field trials show that p-cimenol is effective against the ammonia-producing bacteria present in the digestive tract and in the dejections. Its mechanism of action is described below:

The contact with p-cimenol causes, in ammonia-producing bacteria, the immediate release of the cellular content in the medium, caused by the perforation of the bacterial membrane that leads to the destruction of the cell by osmotic shock [10]. This is because of the interaction of p-cimenol with the lipids that form the cytoplasmic membrane [11].

The second issue of the current invention refers to a procedure to obtain the additive composed of saponins, phenolic compounds and p-cimenol, involving the following steps
(a) to obtain a saponin concentrate from the stem extract of Yucca schidigera;
(b) to obtain a phenolic compound concentrate from the stem extract of Yucca schidigera;
(c) to obtain a p-cimenol concentrate from the leaf extract of Thymus vulgaris;
(d) to mix all the concentrates obtained in the steps (a), (b) and (c) until reaching homogeneity;
(e) to add the corresponding excipient according to the form of the additive, which can be powder of liquid.

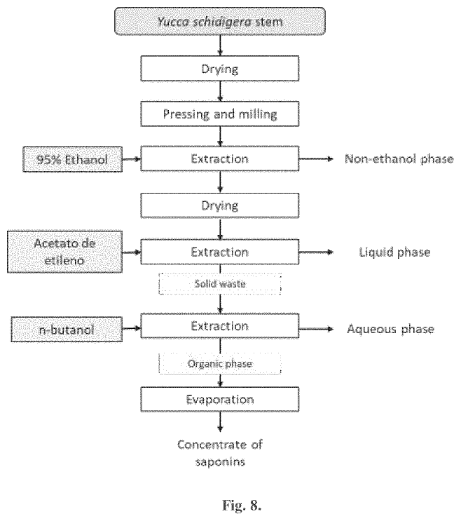

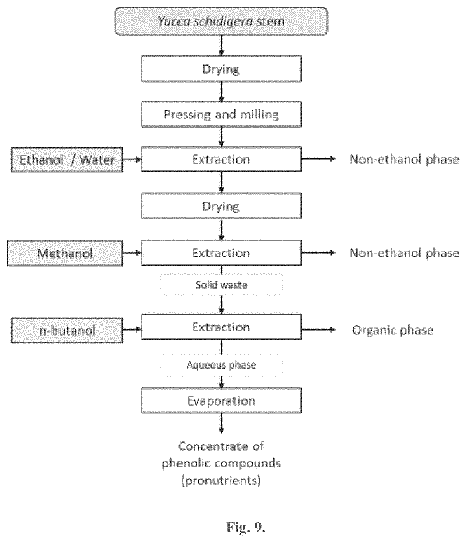

Preferably, step (a) includes the following sub-steps (FIG. 8):
(a1) Dry the stem of Yucca schidigera in a conventional heater at a temperature of 37° C.;
(a2) Press and mill the stem until a homogeneous powder is obtained;
(a3) Extract the powder obtained in (a2) with 95% ethanol three times;
(a4) Allow the ethanolic phases obtained in (a3) to dry completely by exposing them to a temperature of 80° C. for 4 hours;
(a5) Continuously pass through refluxing ethylene acetate for 30 minutes until a viscous brown residue is obtained;
(a6) Separate the brown residue obtained in (a5) into an aqueous and 1-butanol phases;
(a7) Concentrate the organic phase obtained in (a6) by steam evaporation to obtain a brown powder.

This way, the concentrate of saponins is obtained.

Preferably, step (b) includes the following sub-steps (FIG. 9).
(b1) Dry the steam of Yucca schidigera in a conventional heater at a temperature of 37° C.;
(b2) Press and mill the dry stem until a homogeneous powder is obtained;
(b3) Extract the powder obtained in (b2) with a 1:1 v/v ethanol/water solution in a 1:5 w/v by weight of powder and solvent;
(b4) Allow the ethanolic phases obtained in (b3) to dry completely by exposure to 80° C. for 4 hours;
(b5) Extract by continuous steps with a 100% methanol solution;
(b6) Separate the brown residue obtained in (b5) into the aqueous and 1-butanol phases;
(b6) Concentrate the aqueous phase obtained in (b6) by steam evaporation until obtaining a brown powder.

This way, the concentrate of phenolic compounds is obtained.

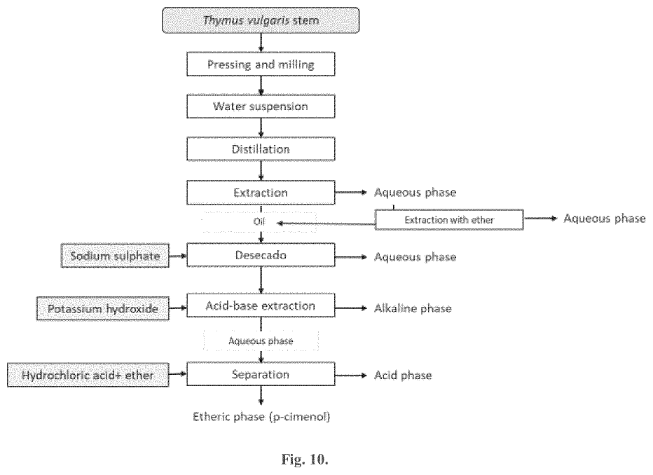

Preferably, step (c) includes the following sub-steps (FIG. 10):
(c1) Cold pressing the leaves of Thymus vulgaris;
(c2) Suspending the powder obtained in (c1) in water;
(c3) Distilling the oil from the extract of the leaves;
(c4) Extract the oil from the aqueous phase;
(c5) Extract the phenolic content of the oil with a base and dissolving it in water;
(c6) Extract the p-cimenol with ether;
(c7) Evaporate the ether.

Through this phase (c) the p-cimenol concentrate is obtained.

The present invention is further illustrated through the reference of the following examples, without them representing a limitation of the scope of the present invention.

### EXAMPLES

### Example 1. Obtention of Saponins from the Stem of Yucca schidigera

To obtain a saponin concentrate, the stem of Yucca schidigera was dried at a temperature of 37° C. for 12 hours. Next, the dry stem of Yucca schidigera was pressed at room temperature. The material obtained contained saponins in 1.2% of its weight.

To obtain a higher concentration of active ingredient (saponins), 1 kg of Y. schidigera stem (dried and ground) was extracted with 3 liters of 95% ethanol in order to separate the ethanolic phase (with saponins) from the non-ethanolic one, which was discarded. The process was repeated three times to obtain a product of higher purity.

The ethanolic phases obtained by exposure to 80° C. for 4 hours were allowed to dry completely. Next, the material was extracted with 100 ml of ethylene acetate in continuous passes for 30 minutes until a viscous brown residue was obtained, which was separated into the aqueous phase and organic phase by extracting with 100 ml of 1-butanol.

The aqueous phase was discarded, and the organic phase was concentrated by steam evaporation until a brown powder was obtained, which corresponds to the saponins concentrate from the stem of Y. schidigera. This material had a concentration of active ingredients of between 6% and 13% by weight.

A standardization of the concentrated extract was carried out to check its purity and richness.

### Example 2. Obtention of Phenolic Compounds from the Stem of Yucca schidigera

To obtain a concentrate of the phenolic compounds, the stem of Yucca schidigera was dried at a temperature of 37° C. for 12 hours. Next, the dry stem of Yucca schidigera was pressed at room temperature. The material obtained contained the phenolic compounds in a 0.5% by weight.

To obtain a higher concentration of the active ingredients, an extraction of 1 kg of Yucca schidigera stem (dry and ground) was carried out with 5 kg of ethanol-water solution. The ethanolic phase obtained was allowed to dry completely by exposure to a temperature of 80° C. for 4 hours in a low-pressure evaporator The pressure below 1 atm facilitates the evaporation process.

An extraction was carried out with 100 ml of 100% methanol at room temperature, which was repeated twice, so that a brown residue remains, which was separated into aqueous phase and phase 1-butanol by adding 50 ml of 1-butanol. Finally, the organic phase was discarded and the aqueous phase was concentrated by evaporation with steam until a brown powder was obtained, which corresponded to the concentrate of phenolic compounds from the stem of Y. schidigera. This material contained a concentration of active ingredients of 9.4%, considering the sum of all phenolic compounds, which includes resveratrol and yuccaoles, mostly.

The standardization of the concentrated extract was carried out to check its purity and richness.

### Example 3. Obtention of p-Cimenol from the Leaves of Thymus vulgaris

To obtain the concentrated extract of p-cimenol, previously dried and ground thyme leaves (Thymus vulgaris) were cold pressed they became a homogeneous powder. The concentration of p-cimenol in the dried thyme leaves was of 0.4%.

To obtain a higher concentration of active ingredient, the ground leaves of Thymus vulgaris were introduced into a container with enough water to achieve the suspension of the sample, with a proportion of 1 kg of dry T. vulgaris in 3 liters of water.

The least manipulation of the sample was sought in order not to degrade the oils, which are the main source of the compound to be purified. Therefore, a steam distillation was used to extract the oil from T. vulgaris. Due to the fact that it is a highly volatile oil and insoluble in water, it was expected that the product presents two phases. Subsequently, an extraction was carried out to separate the pure oil with a separating funnel. The oil was separated in a covered container protected from light to avoid light decomposition.

A new extraction with ether was carried out with the aqueous part to achieve, in this way, to finally separate the surplus oil that were solubilized in this phase. The remaining traces of water were extracted from the ethereal phase with sodium sulfate as a desiccant. To reduce the number of components to be separated by chromatography, an acid-base extraction was performed.

To obtain p-cimenol, which is one of the most acidic compounds in the oil, an acid-base extraction was carried out. First, the oils obtained were placed together with distilled water in the separatory funnel. Next, 50 ml of potassium hydroxide 1N were added, causing p-cimenol, being one of the most acidic compounds present in the oil, to migrate to the aqueous phase.

Once the aqueous phase was isolated from the remainder, it was transferred to a new separatory funnel for acidification with 15 ml of 2N hydrochloric acid, and 100 ml of ether were added. In this way, the ethereal phases were obtained, which contained a higher concentration of p-cimenol.

All the ethereal phases were combined and filtered with anhydrous sodium sulfate as a desiccant to remove traces of water. Subsequently, the compound was heated in a water bath to evaporate the ether and obtain, in this way, the isolated phenols. This oil was absorbed with a bentonite, which allows to have the product in fine powder with a 15% to 17% by weight of p-cimenol.

A standardization of the concentrated extract was carried out to check its purity and richness.

### Example 4. Obtention of the Composition of the Invention in Solid Format (Powder)

Once all the active ingredients were purified (saponins, phenolic compounds and p-cimenol), and after the quantitative analysis to check all concentrations was performed, the preparation of the final product was carried out.

This preparation took place by simple mixing of the concentrated extracts to obtain the product in the solid form and the subsequent addition of a powdered excipient.

For the preparation of the composition of the invention powder, 37.5 kg of extract concentrated in saponins and 37.5 kg of concentrated extract in phenolic compounds from the stem of Yucca schidigera and 10 kg of concentrated extract of p-cimenol from Thymus vulgaris were added. They were mixed for 6 minutes, at which time the homogeneity of the product could be ensured. The product was then ground to ensure appropriate granulometry to be used in industrial facilities, which are the end users of the product, and 15 kg of powdered excipient was added. The product obtained by incorporating natural plant ingredients is ready to be consumed with a guaranteed minimum composition of 2.25% by weight of saponins, 3.5% by weight of phenolic compounds and 1.6% by weight of p-cimenol.

It was properly packaged.

### Example 5. Obtention of the Invention in Liquid Format

Once all the active ingredients were purified (saponins, phenolic compounds and p-cimenol), and after the quantitative analysis to check all concentrations was performed, the preparation of the final product was carried out.

This preparation took place by simple mixing of the concentrated extracts to obtain the product in the form of a solid and the subsequent addition of an excipient in liquid.

For the preparation of the composition of the invention in liquid, 37.5 kg of extract concentrated in saponins and 37.5 kg of extract concentrated in phenolic compounds from the stem of Yucca schidigera, 10 kg of concentrated extract of p-cimenol from Thymus vulgaris were added. They were mixed for 6 minutes, at which time the homogeneity of the product could be ensured. The product was then grounded to ensure appropriate granulometry for use in industrial facilities, the end users of the product, and 15 L of excipient in liquid were added. The product obtained by incorporating natural plant ingredients is ready to be consumed with a guaranteed minimum composition of 2.25% by weight of saponins, 3.5% by weight of phenolic compounds and 1.6% by weight of p-cimenol.

It was properly packaged. The product should be shaken prior to its use.

### Example 6. Efficacy Tests of the Composition of the Invention

To demonstrate the efficacy of the product or the composition of the invention on the levels of environmental ammonia on the farm and the composting pits, several trials have been carried out in poultry and pigs where the effect of different doses of the product described in this invention on the levels of environmental ammonia is verified.

Example 6.1. In a first trial to reduce the concentration of environmental ammonia in the composting pits of a commercial farm in Mesa de los Santos (Colombia) with 840,000 broilers, a Toxi RAE Pro Digital Sensor measurement system was used for the determination of this gas.

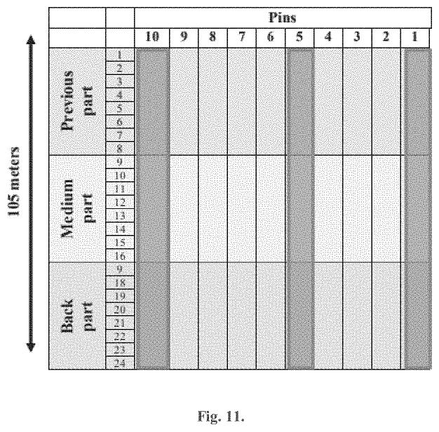

The composition of the invention in solid format (powder) was added to the poultry feed continuously at a dose of 125 g of invention per tor of feed. The measurements were made in the different areas (previous, middle and back) of 3 of the 10 composting pits, more specifically in pits 1.5 and 10 (FIG. 11), whose content came from the poultry farm. The first measurement was made before the administration of the composition of the invention to animals. The second measurement was made one month after the start of administration of the composition of the invention.

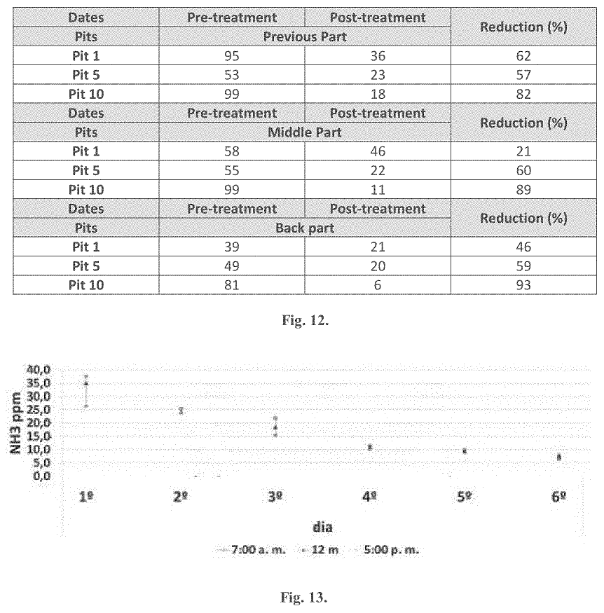

The first measurements gave higher concentrations of environmental ammonia than the second. More specifically, the second measurements showed an average reduction in ammonia concentration close to 67% in the previous part, 57% in the middle part and 66% in the back of the analyzed pits (FIG. 12).

In short, the composition of the invention was able to reduce the concentration of ammonia by approximately 60% and had a prolonged effect over time, up to one month after starting the administration of the product.

Example 6.2. In a second trial to reduce environmental ammonia concentration and improve welfare in a broiler farm in Cerro Azul (Panama); ammonia concentrations were measured in a control batch without the product and in a batch that received the powdered product for 36 days. The productive results and prevalence of ascites, a clinical sign related to high concentrations of environmental ammonia, were also evaluated. This relationship is due to the fact that when ammonia levels increase, animals suffer respiratory problems and this reduces gas exchange, causing them to decrease oxygen levels in the body. As a result, there is an increase in the heart rate and the blood pressure that leads to the transfer of fluid from the arteries to the abdominal cavity (ascites).

Batches:
Control: broilers that do not receive any supplement to control ammonia levels on the farm (200 birds).
Treatment: the composition of the invention was included at the rate of 0.5 kg of composition of the invention per ton of feed continuously for 36 days (200 birds).

36 days after the start of product administration, the environmental ammonia levels were 80 ppm in the control batch and 25 ppm in the treatment batch, representing a reduction of 68.8%.

In general, the productive results were better in the treatment batch, which obtained a final weight of 2.36 kg against the 1.85 kg of the control group; a conversion rate of 1.69 versus 1.85 in the control batch and a reduction in the mortality derived from ascites, which was 2.1% versus 3.6% in the control group.

Based on these results, it can be estimated that for every million broilers raised for 36 days supplemented with the composition of the invention, this farm could reduce environmental ammonia levels by 68.7%, which would allow it to produce 450 tons more of meat and save 377.6 tons of feed.

Example 63. In a third study in pigs, the concentration of environmental ammonia was evaluated in a control batch and a treatment batch in an experimental farm in Almazán (Soria) to determine if the composition of the invention in liquid format could reduce the load of environmental ammonia in 50 days.

Batches:
Control: pigs that do not receive any supplements to control ammonia levels on the farm.
Treatment: the composition of the invention was included at the rate of 0.5 liters of invention per ton of feed continuously for 50 days.

After 50 days of testing, the control batch showed environmental ammonia levels of 100 ppm, while the treatment batch it was 25 ppm, which implies a reduction of 75%.

Weight gain was higher in the treatment batch, 750 g/day/pig compared to 575 g/day/pig in the control batch. The feed conversion rate also improved in the treatment batch, more specifically, by 18%, as it was 2.90 in the treatment batch and 3.54 in the control batch.

Example 6.4. In a fourth trial to assess the concentration of environmental ammonia in a farm with 396 pre-fattening pigs in Colombia, the levels of this gas were evaluated daily for 6 days, three times a day (morning, noon and afternoon). The composition of the invention was added to the drinking water continuously for 5 days at a rate of 0.125 ml of composition of the invention per liter of drinking water. The trial consisted of a single batch. Ammonia measurements were made the day before starting the administration of the composition of the invention and the following 5 days, always at 7:00, 12:00 and 17:00 hours.

The concentration of ammonia in the environment was progressively reduced as the days passed, obtaining a reduction at the end of the trial of 80% at 7:00 a.m., 90% at 12:00 p.m. and 86% at 5:00 p.m., compared to the first measurement (FIG. 13).

In short, the composition of the invention managed to reduce by 85% the concentration of environmental ammonia in pig farms. This concentration went from being 40 ppm, which has negative effects on production, human health and animal welfare, to 6 ppm, a concentration that does not pose a risk to humans or animals.

### REFERENCES

[1] E. S. Soliman, S. A. Moawed, and R. A. Hassan, “Influence of microclimatic ammonia levels on productive performance of different broilers' breeds estimated with univariate and multivariate approaches,” Vet. World, vol. 10, no. 8, pp. 880-887, 2017.
[2] T. T. Canh, A. J. A Aamink. J. B Schutte, A. Sutton, D. J. Langhout, and M. W A. Verstegen, “Dietary protein affects nitrogen excretion and ammonia emission from slurry of growing-finishing pigs,” Livest. Prod. Sci., vol. 56, no. 3, pp. 181-191, 1998.
[3] G. Shu et al., “Protective effect of dietary supplementation of Bupleurum falcatum L saikosaponins on ammonia exposure-induced ileum injury in broilers.” Poult. Sci., vol. 100, no 3, p. 100803, 2021
[4] J Borrell, “Uso de pronutrienmes de origen natural en veterinaria.” RACVE (Real Acad. Ciencias Vet. España), 2005.
[5] D. F McCrory and P. J. Hobbs, “Raw manure increase NH4.” J. Environ. Qual. vol. 30, no. 2, pp. 345-355, 2001
[6] S. Husted. L. S. Jensen. and S. S. Jorgensen, “Reducing ammonia loss from cattle slurry by the use of acidifying additives: The role of the buffer system.” J. Sci. Food Agric., vol. 57, no 3. pp. 335-349, 1991
[7] M. L. Oelschlager. M. S. A Rasheed, B N. Smith. M J. Rincker, and R. N. Dilger, “Effects of Yucca schidigera-derived saponin supplementation during a mixed Eimeria challenge in broilers,” Poultry_Science, vol. 98, no. 8, pp. 3212-3222, 1999.
[8] P. R. Cheeke, S. Piacente, and W. Oleszek, “Anti-inflammatory and anti-arthritic effects of Yucca schidigera: A review,” J. Inflamm., vol. 3. pp. 2-8, 2006.
[9] R. J. Wallace. L. Arthaud. and C. J. Newbold, “Influence of Yucca shidigera extract on ruminal ammonia concentrations and ruminal microorganisms,” Appl. Environ. Microbiol., vol. 60, no. 6, pp. 1762-1767, 1994.
[10] J. Borrell, “Metabolitos fúngicos en los alimentos,” Real Acad. Ciencias Vet. España, 1990.
[11] A. Marchese et al., “Update on monoterpenes as antimicrobial agents: A particular focus on p-cymene,” Materials (Basel)., vol. 10, no. 8. pp. 1-15, 2017.

1. An additive for animals, comprising: saponins, phenolic components and p-cimenol.

2. The additive for animals according to claim 1, wherein the phenolic compounds are resveratrol and yuccaoles or a combination thereof.

3. The additive for animals according to claim 1, wherein saponins are present at least 2.25% by weight in the additive.

4. The additive for animals according to claim 1, wherein phenolic components are present at least 3.5% by weight in the additive.

5. The additive for animals according to claim 1, wherein p-cimenol is present at least 1.6% by weight in the additive.

6. The additive for animals according to claim 1, wherein saponins are contained in the concentrated stem extract of Yucca schidigera.

7. The additive for animals according to claim 6, wherein the concentrated stem extract of Yucca schidigera has a saponins content of 6%-13% by weight.

8. The additive for animals according to claim 1, wherein the phenolic compounds are contained in the concentrated stem extract of Yucca schidigera.

9. The additive for animals according to claim 8, wherein the concentrated stem extract of Yucca schidigera has a phenolic compounds content of at least 9.4% by weight.

10. The additive for animals, according to claim 1, wherein p-cimenol is contained in the concentrated extract of Thymus vulgaris.

11. The additive for animals according to claim 10, wherein the concentrated extract of Thymus vulgaris has a p-cimenol content of 15%-17% by weight.

12. A method to obtain an additive for animals comprising saponins, phenolic compounds and p-cimenol, comprising the following steps:
(a) obtaining a concentrated extract of saponins from the stem of Yucca schidigera;
(b) obtaining a concentrated extract of phenolic compounds from the stem of Yucca schidigera;
(c) obtaining a concentrated extract of p-cimenol from the leaves of Thymus vulgaris;
(d) mixing the concentrated extracts obtained in the steps (a), (b) and (c) until reaching homogeneity;
(e) adding the corresponding excipient according to the form of the additive, which can be powder or liquid.

13. The method according to claim 12, wherein step (a) further comprises:
(a1) drying of the Yucca shidigera stem in a conventional heater at a temperature of 37° C.;
(a2) pressing and milling of the stem until a homogeneous powder is obtained;
(a3) extracting the powder obtained in (a2) with 95% ethanol three times;
(a4) completely drying ethanolic phases obtained in (a3) through the exposition to a temperature of 80° C. for 4 hours;
(a5) continuous extraction with ethylene acetate in reflux for 30 minutes until a brown viscous residue is obtained;
(a6) separating the brown viscous residue obtained in (a5) in aqueous and 1-butanol phases;
(a7) concentrating the organic phase obtained in (a6) through evaporation with vapor until a brown powder is obtained.

14. The method of claim 12, wherein step (b) comprises the following substeps:
(b1) drying of the Yucca schidigera stem in a conventional heater at a temperature of 37° C.;
(b2) pressing and milling of the dry stem until an homogeneous powder is obtained;
(b3) extracting the powder obtained in (b2) with a 1:1 v/v ethanol/water solution in a 1:5 w/v ratio by weight of the powder and solvent;
(b4) drying of the ethanolic phases obtained in (b3) through the exposition at 80° C. for 4 hours;
(b5) extracting with a 100% methanol solution resulting on a brown residue;
(b6) separating the brown residue obtained in (b5) in aqueous and 1-butanol phases;
(b6) concentrating the aqueous phase obtained in (b6) through evaporation with vapor until a brown powder is obtained.

15. The method of claim 12, wherein the step (c) comprises the following substeps:
(c1) cold pressing of Thymus vulgaris leaves,
(c2) water suspension of the powder obtained in (c1); (c3) Distillation of the oil extract of the leaves;
(c4) extracting the oil of the aqueous phase;
(c5) extracting the phenolic content of the oil with a base and solubilization in water; (c6) Extraction of the p-cimenol with ether;
(c7) evaporating the ether.
